(19) United States
(12) Patent Application Publication
(10) Pub. No.: US 2021/0173570 A1
(43) Pub. Date: Jun. 10, 2021

(54) MICRO-PROCESSING CIRCUIT AND DATA PROTECTION METHOD FOR MEMORY THEREOF

(71) Applicant: Nuvoton Technology Corporation, Hsinchu (TW)

(72) Inventor: I-Ching Chen, Hsinchu (TW)

(73) Assignee: Nuvoton Technology Corporation, Hsinchu (TW)

(21) Appl. No.: 17/035,709

(22) Filed: Sep. 29, 2020

(30) Foreign Application Priority Data
Dec. 6, 2019 (TW) 108144605

(51) Int. Cl. G06F 3/06

(52) U.S. Cl. CPC G06F 3/0622; G06F 3/0652; G06F 3/0679

(57) ABSTRACT

A data protection method for a memory includes: detecting a data tampering event to generate a trigger signal; writing a lock signal into the memory during a first time frame based on the lock signal, in which the lock signal is adapted to prevent the protected data from being read; and erasing the protected data based on the lock signal during a second time frame, in which the first time frame precedes the second time frame.

### CROSS-REFERENCE TO RELATED APPLICATION

This application claims the priority benefit of Taiwan application serial no. 108144605, filed on Dec. 6, 2019. The entirety of the above-mentioned patent application is hereby incorporated by reference herein and made a part of this specification.

### BACKGROUND

### Technical Field

The disclosure relates to a micro-processing circuit and a data protection method for a memory thereof, particularly to a micro-processing circuit capable of locking the protected data in real time and a data protection method for a memory thereof.

### Description of Related Art

In the conventional technical field, a microprocessor provides a built-in flash memory for data storage. The advantage is that the microprocessor can directly control the data access operation of the flash memory through the memory controller, which not only provides a faster speed for reading and writing data but also exempts the configuration from installing an external memory, saving both the cost and the space for circuits.

If important data are stored in the flash memory, the conventional data protection mechanism usually erases the protected data stored from the flash memory in the event of a tamper event in order to prevent the protected data from being read.

However, as the operation of erasing data from the flash memory takes a certain amount of time, if the data erasure is interrupted during this period (for example, the power supply of the microprocessor is interrupted), the protected data cannot be fully deleted, allowing the attacker to read part of the protected data.

### SUMMARY

Accordingly, the disclosure provides a micro-processing circuit and a data protection method for a memory thereof, which may effectively prevent the protected data from being read or tampered.

The data protection method for the memory of the present disclosure includes: detecting for a data tampering event to generate a trigger signal; writing a lock signal into the memory during a first time frame based on the trigger signal, in which the lock signal is adapted to prevent the protected data of the memory from being read; based on the lock signal, the protected data in the memory is erased during a second time frame, in which the first time frame precedes the second time frame.

In an embodiment of the present disclosure, the number of bits of the aforementioned lock signal is smaller than a preset value.

In an embodiment of the present disclosure, the number of bits of the aforementioned lock signal is equal to 1, and the memory is a non-volatile memory.

In an embodiment of the present disclosure, the duration of the aforementioned first time frame is shorter than the duration of the second time frame.

In an embodiment of the present disclosure, the step of writing the lock signal into the memory during the first time frame based on the trigger signal includes: when the trigger signal indicates that a data tampering event occurs, the lock signal is written at the first logic level into the memory during the first time frame.

In an embodiment of the present disclosure, the data protection method for the memory further includes: after the second time frame, when the protected data is erased, the lock signal is cleared for the same to be at the second logic level, in which the first logic level is different from the second logic level.

The micro-processing circuit of the present disclosure includes a data tampering event detector, a memory cell array, and a memory controller. The data tampering event detector is configured to detect for a data tampering event to generate a trigger signal. The memory controller is coupled to the data tampering event detector and the memory cell array. The memory controller receives the trigger signal and writes a lock signal into the memory cell array during the first time frame based on the trigger signal, in which the lock signal is adapted to prevent the protected data in the memory cell array from being read. The memory controller erases the protected data from the memory cell array during the second time frame based on the lock signal.

Based on the above, when a data tampering event occurs, the present disclosure may write rapidly the lock signal into the memory. And through the lock signal, the protected data of the memory is locked such that it may not be read. Since the writing operation based on the lock signal may be completed instantly, the probability for an attacker to read the complete or partial protected data may be reduced, thus improving the security of the system.

In order to make the aforementioned features and advantages of the disclosure more comprehensible, embodiments accompanied with drawings are described in detail below.

### BRIEF DESCRIPTION OF THE DRAWINGS

FIG. 1 is a flow chart of a data protection method for a memory according to an embodiment of the present disclosure.

FIG. 2 is a flow chart of a data protection method for a memory according to another embodiment of the present disclosure.

FIG. 3 is a schematic view of a micro-processor according to an embodiment of the present application.

### DESCRIPTION OF THE EMBODIMENTS

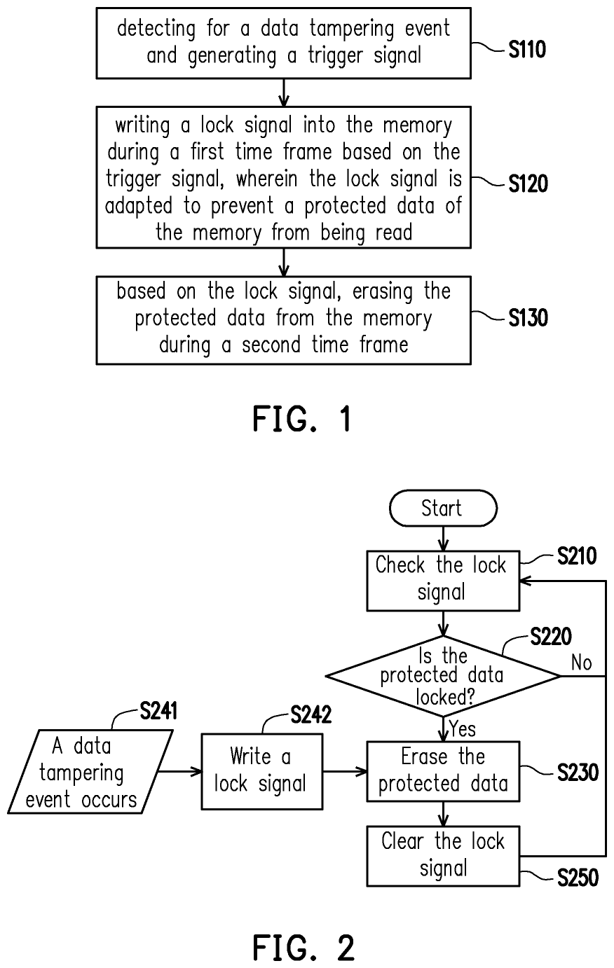

FIG. 1 is a flow chart of a data protection method for a memory according to an embodiment of the present disclosure. Step S110 is a step of detecting for a data tampering event based on which a trigger signal is generated accordingly. Next, in step S120, if a data tampering event occurs, a lock signal is written into the memory during a first time frame based on the trigger signal generated in step S110, in which the lock signal is adapted to prevent the protected data of the memory from being read. In step S130, based on the lock signal in the memory, the protected data in the memory is erased during a second time frame which is after the first time frame.

Specifically, in the embodiment of the present disclosure, the memory in the embodiment of the present disclosure may be a non-volatile memory, such as a flash memory, a resistive memory, or a non-volatile memory in any other form that provides operations like data reading, data writing, and data erasure. In step S110, if a data tampering event is detected, a trigger signal is generated correspondingly, and based on this trigger signal, a lock signal is generated in step S120, and the lock signal is written into the memory.

Note here that in the embodiment of the present disclosure, the number of bits of the lock signal may be smaller than a preset threshold. With such configuration, the time frame for writing the lock signal into the memory may be controlled within a shorter time. In the embodiment of the present disclosure, the number of bits of the lock signal may be 1 bit. Therefore, the operation of writing the lock signal into the memory may be completed instantly. In the embodiment of the present disclosure, when a data tampering event occurs, the lock signal generated based on the trigger signal may be at a first logic level. The first logic level can be logic 0 or logic 1 without having a certain limit.

In the above description, the lock signal serves as the basis for determining whether the protected data in the memory may be read. Specifically, when performing a reading operation on the memory, it is necessary to determine first whether the lock signal stored in the memory is at the first logic level. If the lock signal stored in the memory is at the first logic level, the reading operation for the memory is prohibited and cannot be executed. In contrast, if the lock signal stored in the memory is not at the first logic level (but at the second logic level), the reading operation for the memory may be executed.

In step S130, based on the lock signal which is at the first logic level, the protected data in the memory is erased during the second time frame which is after the first time frame. Based on the fact that the number of bits of the protected data is greater than the number of bits of the lock signal, the duration of the second time frame is longer than the duration of the first time frame.

Note here that when a data tampering event occurs, the embodiment of the present disclosure quickly writes the lock signal into the memory based on the trigger signal, and instantly completes the locking operation on the protected data in the memory to prevent the protected data from being read. Since the time frame needed for data writing operation based on the lock signal is very short, the attacker cannot fulfill his attempt to read the protected data by interrupting instantly the power supply of the memory. Moreover, after the data writing operation of the lock signal is completed, the embodiment of the present disclosure erases the protected data from the memory, thereby preventing the possibility of the protected data from being read by an attacker.

Since the memory is a non-volatile memory, an interruption of the power supply of the memory does not change the value of the lock signal in the memory. In other words, the interruption of the power supply of the memory does not lend a hand to stealing the protected data in the memory.

Furthermore, after the protected data is fully erased from the memory, the embodiment of the present disclosure may clear the lock signal in the memory, for example, by making the lock signal in the memory for the same to be at the second logic level.

FIG. 2 is a flow chart of a data protection method for a memory according to another embodiment of the present disclosure. In step S210, the lock signal stored in the memory is checked, and it is determined whether the lock signal indicates that the protected data is in a locked condition (step S220). When it is determined in step S220 that the lock signal indicates that the protected data is in the locked condition, step S230 is executed. On the contrary, if it is determined in step S220 that the lock signal indicates that the protected data is not in the locked condition, step S210 is executed again.

On the other hand, in step S241 of the embodiment of the present disclosure, the presence or absence of the data tampering events is detected in real time. When a data tampering event occurs, by generating a trigger signal, the lock signal is written at the first logic level into the memory in step S242. And, in step S230, the protected data in the memory is erased. After step S230 is completed, step S250 is executed to clear the locked data in the memory for the same to be at the second logic level.

After step S250 is completed, step S210 is executed again to check the logic level of the lock signal again.

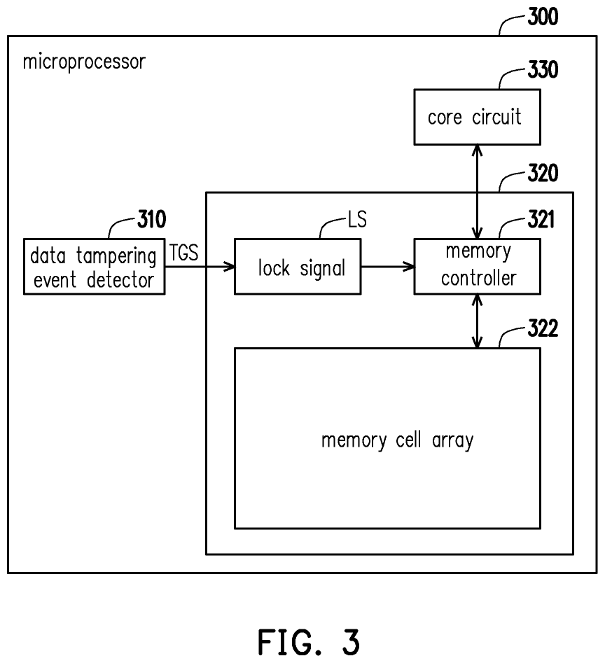

FIG. 3 is a schematic view of a microprocessor according to an embodiment of the present application. The microprocessor 300 includes a data tampering event detector 310, a memory 320, and a core circuit 330. The memory 320 includes a memory controller 321 and a memory cell array 322. The data tampering event detector 310 is coupled to the memory 320 for detecting for a data tampering event. When the data tampering event detector 310 detects a data tampering event, a trigger signal TGS is generated and transmitted to the memory 320.

The memory 320 is further coupled to the core circuit 330. The memory 320 may generate a lock signal LS base on the received trigger signal TGS. The memory controller 321 receives the lock signal LS, and writes the lock signal LS, for example, at the first logic level into one or part of the bits of the memory cell array 322. In addition, the memory controller 321 may interpret in real time the logic level of the lock signal LS in the memory cell array 322, and when the lock signal LS is at the first logic level, the protected data of the memory cell array 322 is erased.

On the other hand, after the memory controller 321 completes the erasure of the protected data, the memory controller 321 may additionally clear the lock signal LS in the memory cell array 322 for the same to be at the second logic level.

Incidentally, the core circuit 330 may send an access command to command the memory 320 to perform an access operation. After the memory controller 321 receives the access command sent by the core circuit 330, it may first read the lock signal LS stored in the memory cell array 322. If the lock signal LS stored in the memory cell array 322 is at the first logic level, the memory controller 321 blocks the access command sent by the core circuit 330 and does not transmit the protected data in the memory cell array 322 to the core circuit 330. In contrast, if the lock signal LS stored in the memory cell array 322 is at the second logic level, the memory controller 321 accesses the memory cell array 322 based on the access command sent by the core circuit 330.

In the present embodiment, the data tampering event detector 310 may be constructed using circuits familiarly known by those skilled in the art, and there is no particular limitation thereto. In addition, the memory cell array 322 may be a non-volatile memory cell array, and the number of bits of the lock signal LS may be 1.

In summary, when a data tampering event occurs, the present disclosure instantly writes a lock signal having a small number of bits into the memory, so as to complete the locking operation of the protected data in real time. With such configuration, the attacker is left with no time to breach the protection mechanism of the protected data by interrupting the power supply. And this effectively prevents any part of the protected data from being read.

Although the disclosure has been disclosed by the above embodiments, they are not intended to limit the disclosure. To any one of ordinary skill in the art, modifications and embellishment to the disclosed embodiments may be made without departing from the spirit and the scope of the disclosure. Accordingly, the scope of the disclosure is defined by the claims attached below and their equivalents.

What is claimed is:

1. A data protection method for a memory, comprising:
detecting for a data tampering event and generating a trigger signal;
writing a lock signal into the memory during a first time frame based on the trigger signal, wherein the lock signal is adapted to prevent a protected data of the memory from being read; and
based on the lock signal, erasing the protected data from the memory during a second time frame,
wherein the first time frame precedes the second time frame.

2. The data protection method for the memory according to claim 1, wherein a number of bits of the lock signal is smaller than a preset value.

3. The data protection method for the memory according to claim 1, wherein a number of bits of the lock signal is equal to 1, and the memory is a non-volatile memory.

4. The data protection method for the memory according to claim 1, wherein a duration of the first time frame is shorter than a duration of the second time frame.

5. The data protection method for the memory according to claim 1, wherein writing the lock signal into the memory during the first time frame based on the trigger signal comprises:
when the trigger signal indicates that the data tampering event occurs, writing the lock signal at a first logic level into the memory during the first time frame.

6. The data protection method for the memory according to claim 5, further comprising:
after the second time frame, when the protected data is erased, clearing the lock signal to be at a second logic level,
wherein the first logic level is different from the second logic level.

7. A micro-processing circuit, comprising:
a data tampering event detector, configured to detect for a data tampering event and generate a trigger signal;
a memory cell array; and
a memory controller, coupled to the data tampering event detector and the memory cell array, receiving the trigger signal and writing a lock signal into the memory cell array during a first time frame based on the trigger signal, wherein the lock signal is adapted to prevent a protected data in the memory cell array from being read, and the memory controller erases the protected data from the memory cell array during a second time frame based on the lock signal.

8. The micro-processing circuit according to claim 7, further comprising:
a core circuit, coupled to the memory controller, and adapted to send an access command to the memory controller.

9. The micro-processing circuit according to claim 8, wherein the core circuit reads the protected data in the memory cell array based on the access command, and the memory controller determines whether to provide the protected data to the core circuit based on the lock signal.

10. The micro-processing circuit according to claim 7, wherein a number of bits of the lock signal is smaller than a preset value.

11. The micro-processing circuit according to claim 7, wherein a number of bits of the lock signal is equal to 1, and the memory cell array is a non-volatile memory.

12. The micro-processing circuit according to claim 7, wherein a duration of the first time frame is shorter than a duration of the second time frame.

13. The micro-processing circuit according to claim 7, wherein when the trigger signal indicates that the data tampering event occurs, the memory controller writes the lock signal at a first logic level into the memory cell array during the first time frame.

14. The micro-processing circuit according to claim 13, wherein after the second time frame, when the protected data is erased, the memory controller clears the lock signal to be at a second logic level,
wherein the first logic level is different from the second logic level.
